(19) United States
(12) Patent Application Publication
(10) Pub. No.: US 2025/0033440 A1
(43) Pub. Date: Jan. 30, 2025

(54) SUN VISOR RETAINER SYSTEM

(71) Applicant: GM Global Technology Operations LLC, Detroit, MI (US)

(72) Inventors: Richard Mark McFadden, Oxford, MI (US); Douglas R. Rosinski, JR., Warren, MI (US)

(73) Assignee: GM Global Technology Operations LLC, Detroit, MI (US)

(21) Appl. No.: 18/359,269

(22) Filed: Jul. 26, 2023

(51) Int. Cl. B60J 3/02

(52) U.S. Cl. CPC B60J 3/023

(57) ABSTRACT

A vehicle sun visor system includes a visor and a visor retainer. The visor includes a receptacle having at least one catch. The visor retainer includes one or more detents configured to selectively engage the catch of the visor. The visor retainer includes a retainer head having a first retainer side including a first detent and a second retainer side formed on an opposite side from the first retainer side and including a second detent. The retainer head includes a first guide channel extending from a rear side to the first detent a second guide channel extending from the rear side to the second detent.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a system for retaining a sun visor in a stowed position in a motor vehicle.

Drivers and passengers of motor vehicles are, from time to time, subjected to undesirable lighting situations originating from outside the motor vehicle. For example, the sun may be low on the horizon and be shining brightly through the windshield, or the sun may be bothersome as it shines through a side window. For these and other situations of the sort, sun visors are provided adjacent the windshield to alleviate illumination discomfort.

Sun visors may pivotally attach to an interior panel of a vehicle body via a support rod to allow the sun visor to move between a stowed state against a headliner or pivoted down into a use state to shield the eyes of the passenger from incoming sunlight. Additionally, the sun visor may be configured to rotate about the support rod between a forward deployed position adjacent to a front windshield of the vehicle and a side deployed position adjacent to a side passenger window: Thus, the sun visor can be moved to shield the passenger from the sun through either of the front windshield or the side passenger window.

### SUMMARY

An aspect of the disclosure includes a sun visor system for a vehicle. The sun visor system includes a visor panel including a retainer receptacle having at least one catch. The sun visor system also includes a retainer including at least one detent configured to selectively engage the at least one catch of the visor panel and to disengage from the at least one catch of the visor panel in a first direction and in an opposite second direction.

The sun visor system may include one or more of the following optional features. The retainer includes a retainer head having a first retainer side including a first detent and a second retainer side formed on an opposite side from the first retainer side and including a second detent. The retainer head includes a front side and a rear side at an opposite end from the front side, and each of the first retainer side and the second retainer side extend between the front side and the rear side. The first retainer side includes a first guide channel extending from the rear side to the first detent and the second retainer side includes a second guide channel extending from the rear side to the second detent. Each of the first guide channel and the second guide channel includes a height that tapers along a direction from the rear side to the detent. The retainer head includes an upper side and a bottom end formed on an opposite side from the upper side, the front side and the rear side converging along a direction from the upper side to the bottom end. The first guide channel includes a first inner guide surface recessed from the first retainer side and the second guide channel includes a second inner guide surface recessed from the second retainer side. The retainer receptacle includes a first receptacle side including a first catch configured to engage the first detent and a second receptacle side including a second catch configured to engage the second detent.

Another aspect of the disclosure provides a retainer for a vehicle sun visor system. The retainer includes a retainer head having a first retainer side including a first detent and a second retainer side formed on an opposite side from the first retainer side and including a second detent. The retainer further includes a retainer anchor extending from the retainer head and configured to secure the retainer to a vehicle body.

The retainer may include one or more of the following optional features. The retainer head includes a front side and a rear side at an opposite end from the front side, and each of the first retainer side and the second retainer side extends between the front side and the rear side. The first retainer side includes a first guide channel extending from the rear side to the first detent and the second retainer side includes a second guide channel extending from the rear side to the second detent. Each of the first guide channel and the second guide channel includes a height that tapers along a direction from the rear side to the respective first detent and second detent. The retainer head includes an upper side and a bottom end formed on an opposite side from the upper side, the first retainer side and the second retainer side converging along a direction from the upper side to the bottom end. The first guide channel includes a first inner guide surface recessed from the first retainer side and the second guide channel includes a second inner guide surface recessed from the second retainer side.

Another aspect of the disclosure provides a motor vehicle. The motor vehicle includes a vehicle body defining a passenger compartment having a headboard. The motor vehicle also includes a visor panel pivotally attached to the headboard and defining a retainer receptacle having at least one catch. The motor vehicle further includes a retainer attached to the headboard and including one or more detents configured to selectively engage the catch of the visor panel.

The motor vehicle may include one or more of the following optional features. The retainer includes a retainer head including a front side and a rear side at an opposite end from the front side: a first retainer side extending between the front side and the rear side and including a first detent and a first guide channel extending from the rear side to the first detent; and a second retainer side formed on an opposite side from the first retainer side and including a second detent and a second guide channel extending from the rear side to the second detent. Each of the first guide channel and the second guide channel includes a height that tapers along a direction from the rear side to the respective first detent and second detent. The retainer head includes an upper side and a bottom end formed on an opposite side from the upper side, the first retainer side and the second retainer side converging along a direction from the upper side to the bottom end, and the first guide channel includes a first inner guide surface recessed from the first retainer side and the second guide channel includes a second inner guide surface recessed from the second retainer side and parallel to the first inner guide surface. The first guide channel diverges from the second guide channel along a direction from the rear side to the first detent. The first guide channel is parallel to the second guide channel along a direction from the bottom end to the upper side.

### BRIEF DESCRIPTION OF THE DRAWINGS

The drawings described herein are for illustrative purposes only of selected configurations and are not intended to limit the scope of the present disclosure.

FIG. 1 is a partial perspective view of a passenger compartment of a motor vehicle including an example of a visor system according to the principles of the present disclosure, wherein the visor system is in a decoupled state;

FIG. 2 is a partial perspective view of the passenger compartment of the motor vehicle including the example of the visor system of FIG. 1, wherein the visor system is in a coupled state:

FIG. 3 is a partial perspective view of the passenger compartment of the motor vehicle including the example of the visor system of FIG. 1, wherein the visor system is in a post-impact state:

FIG. 4 is a perspective view of an example of a visor retainer of the visor system of FIG. 1:

FIG. 5 is a rear side elevation view of the visor retainer of FIG. 4:

FIG. 6 is a side elevation view of the visor retainer of FIG. 4; and

FIG. 7 is a partial cross-sectional view of the visor system of FIG. 2, taken along section line 7-7 of FIG. 2.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including.” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

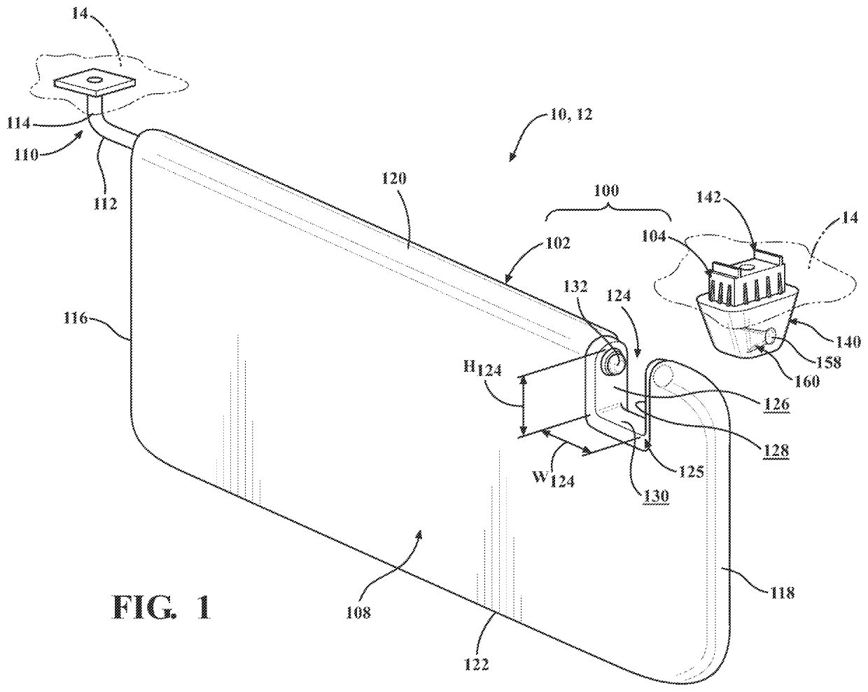

Referring to FIGS. 1-3, a visor system 100 according to an example of the present disclosure is provided. The visor system 100 is configured to be implemented in a motor vehicle including a vehicle body 10 having a headboard 12 enclosing an upper portion of a passenger compartment 14. While FIGS. 1-3 show the passenger compartment generically including cutaway sections of the vehicle headboard 12, it should be appreciated that the visor system 100 of the present disclosure may be implemented on all types of motor vehicles or in other applications utilizing adjustable sun visors.

Referring still to FIGS. 1-3, the visor system 100 includes a visor 102 and a visor retainer 104 each attached to respective sections of the headboard 12 of the vehicle body 10. The visor 102 generally includes a visor panel 108 pivotally attached to the headboard 12 by a visor support rod 110. As shown, the visor support rod 110 includes an elbow-shaped rod including a first support rod segment 112 attached to the visor panel 108 and defining a first pivot axis of the visor 102. The visor support rod 110 further includes a second support rod segment 114 extending from the first support rod segment 112 at a transverse angle and defining a second pivot axis of the visor 102. Generally, the first support rod segment 112 defines a substantially horizontal pivot axis of the visor panel 108 while the second support rod segment 114 defines a substantially vertical pivot axis of the visor panel 108. Thus, in use, the visor 102 rotates about the first support rod segment 112 to transition between a fully stowed state (e.g., visor panel 108 against the headboard 12) and a deployed state (e.g., visor panel 108 pulled down from the headboard 12). The visor 102 rotates about the second support rod segment 114 to transition between a windshield-deployed state (e.g., down in the windshield) and a passenger-window-deployed state (e.g., down in the passenger window).

The visor panel 108 may be described as including a length extending from an outboard edge 116 attached at the support rod 110 to an inboard edge 118 formed on an opposite end of the visor panel 108 from the outboard edge 116. The visor panel 108 may be further described as including a height extending from an upper edge 120 adjacent to the headboard 12 to a lower edge 122 formed at an opposite end from the upper edge 120. In the illustrated example, the support rod 110 is attached adjacent to the upper edge 120, whereby a lower portion of the visor panel between the upper edge 120 and the lower edge 122 pivots about the first support rod segment 112 to move between the stowed state and the deployed state.

The visor panel 108 further includes a retainer receptacle 124 formed along the upper edge 120. In the illustrated example, the retainer receptacle 124 is disposed adjacent to the inboard edge 118 of the visor panel 108. Generally, the retainer receptacle 124 is configured to selectively engage the visor retainer 104 adjacent to the inboard edge 118 of the visor panel 108. Thus, when the retainer receptacle 124 is engaged with the visor retainer 104, the visor 102 is coupled to the headboard 12 at the outboard edge 116 by the support rod 110 and at the inboard edge 118 by the retainer receptacle 124. As described in greater detail below, the retainer receptacle 124 is configured to rotationally engage the visor retainer 104, whereby the visor 102 can rotate about a rotational axis A₁₀₂ defined along the first support rod segment 112 and the visor retainer 104.

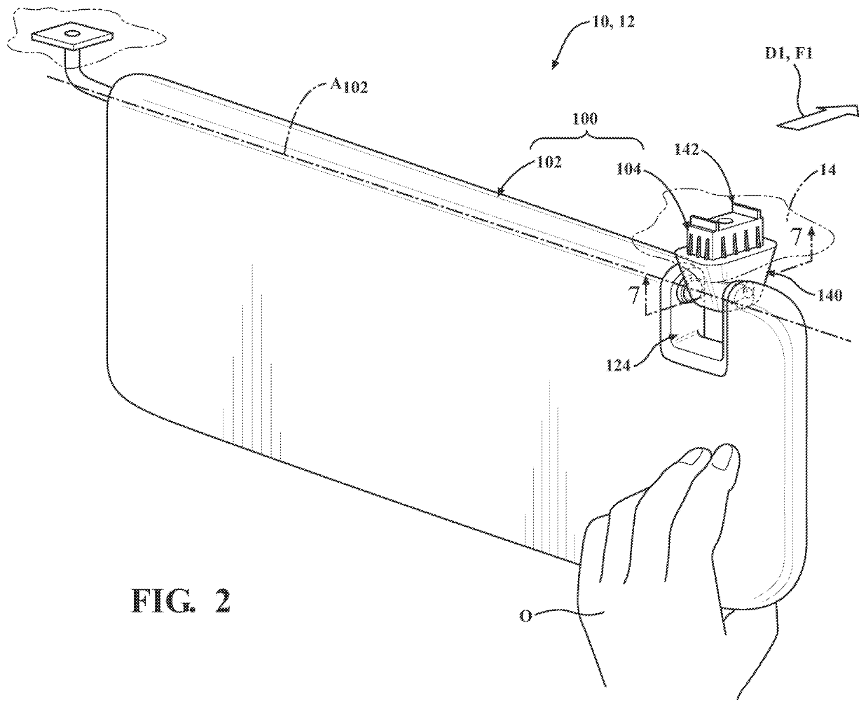

With continued reference to FIG. 1, the retainer receptacle 124 defines a notch or recess in the upper edge 120 that is configured to receive a portion of the visor retainer 104 when in the engaged position (FIG. 2). The retainer receptacle 124 includes an outboard side surface 126 and an opposite inboard side surface 128 spaced apart from and facing the outboard side surface 126 to define a width W₁₂₄ of the retainer receptacle 124. The retainer receptacle further includes a bottom side surface 130 recessed from the upper edge 120 of the visor panel 108 to define a height H₁₂₄ of the retainer receptacle 124. Generally, the height H₁₂₄ and the width W₁₂₄ of the retainer receptacle 124 are configured to receive a corresponding portion of the visor retainer 104 when the visor 102 is engaged with the visor retainer 104.

The retainer receptacle 124 includes one or more catches 132 configured to engage the visor retainer 104 when the visor 102 is in the stowed state, as described in greater detail below: In the illustrated example, the retainer receptacle 124 includes a first catch 132 disposed on the outboard side surface 126 of the retainer receptacle 124 and a second catch 132 disposed on the inboard side surface 128 of the retainer receptacle 124, opposite the first catch 132. As best shown in FIG. 7, the catches 132 are aligned with each other across the retainer receptacle 124. As shown, the retainer receptacle 124 may optionally be defined by a receptacle frame 125 configured to attach to a corresponding recess formed in the upper edge 120 of the visor panel 108. Alternatively, the retainer receptacle 124 may be integrally formed as portion or component of the visor panel 108. In the illustrated example, the catches 132 are formed as hemispherical protrusions extending into the retainer receptacle from each of the side surfaces 126, 128. However, other geometries may be utilized. In some examples, the catches 132 may be stationary elements that are integrally formed with the retainer receptacle 124, such as molded protrusions. Alternatively, and as shown in the illustrated example, the catches 132 may be dynamic elements configured to engage the visor retainer 104. For instance, the catches 132 may include spherical ball bearings 132 received within a socket 136 formed in the retainer receptacle 124. The socket 136 may include a biasing element 138, such as a coil spring, that biases the ball bearings 132 to an extended position (FIG. 7). As the retainer 104 is inserted into the retainer receptacle 124, surfaces of the retainer 104 may move the ball bearings 132 in a direction away from one another and against the bias exerted on the ball bearings 132 by the biasing element 138. In so doing, the surfaces of the retainer 104 move the ball bearings 132 into a retracted position at least partially within the socket 136.

Referring now to FIGS. 4-6, the visor retainer 104 includes a retainer head 140) and a retainer anchor 142 extending from the retainer head 140. Generally, the retainer head 140) is configured to interface with the retainer receptacle 124 to selectively secure the visor 102 to the headboard 12. The retainer anchor 142 is configured to attach to the headboard 12 of the vehicle body 10 to support the visor retainer 104 at a desired location on the vehicle body 10.

The visor retainer 104 may be generally described as having a height extending from a top end 144 to a bottom end 146 formed on an opposite end from the top end 144. As shown, the retainer head 140 is disposed at the bottom end 146 of the visor retainer 104 and the retainer anchor 142 is disposed at the top end 144 of the visor retainer 104. The visor retainer 104 and each of the retainer head 140 and the retainer anchor 142 may be described in terms of an outboard side 148 and an inboard side 150 disposed on an opposite side from the inboard side 148. Likewise, visor retainer 104 and each of the retainer head 140) and the retainer anchor 142 may be described in terms of a front side 152 and a rear side 154 disposed on an opposite side from the front side 152. For example, either of the retainer head 140) or the retainer anchor 142 may be described as including features formed relative to the outboard side 148, the inboard side 150, the front side 152, and/or the rear side 154.

With continued reference to FIGS. 4-6, the retainer head 140 has a height H₁₀₄ that extends from the bottom end 146 to an upper side 156 disposed intermediate the bottom end 146 and the top end 144 of the visor retainer 104. Thus, the distance from the bottom end 146 to the upper side 156 defines a height H₁₄₀ of the retainer head 140, which corresponds to a distance that the retainer head 140 protrudes from the headboard 12 when the visor retainer 104 is installed on the vehicle body 10.

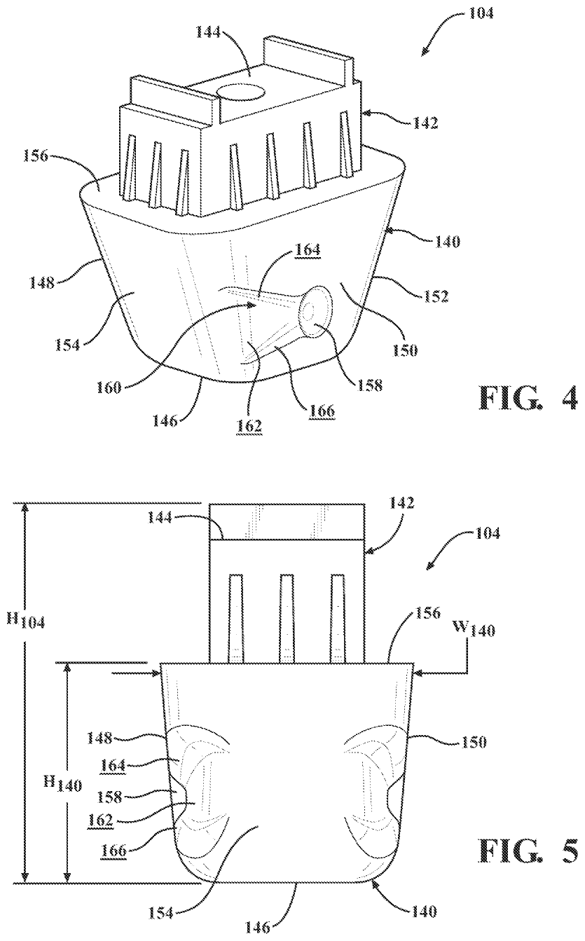

As shown in FIG. 5, the outboard side 148 of the retainer head 140) and the inboard side 150 of the retainer head 140) each extend from the bottom end 146 to the upper side 156 of the retainer head 140, whereby a distance from the outboard side 148 to the inboard side 150 defines a width W₁₄₀ of the retainer head 140. In the illustrated example, the width W₁₄₀ of the retainer head 140 tapers continuously along a direction from the upper side 156 to the bottom end 146. In other words, the outboard side 148 and the inboard side 150 converge with each other along the direction from the upper side 156 to the bottom end 146. While the illustrated example shows the width W₁₄₀ having a constant taper from the upper side 156 to the bottom end 146 (i.e., the sides 148, 150 are straight), other examples may include a variable taper, whereby the sides 148, 150 are arcuate or contoured between the upper side 156 and the bottom end 146.

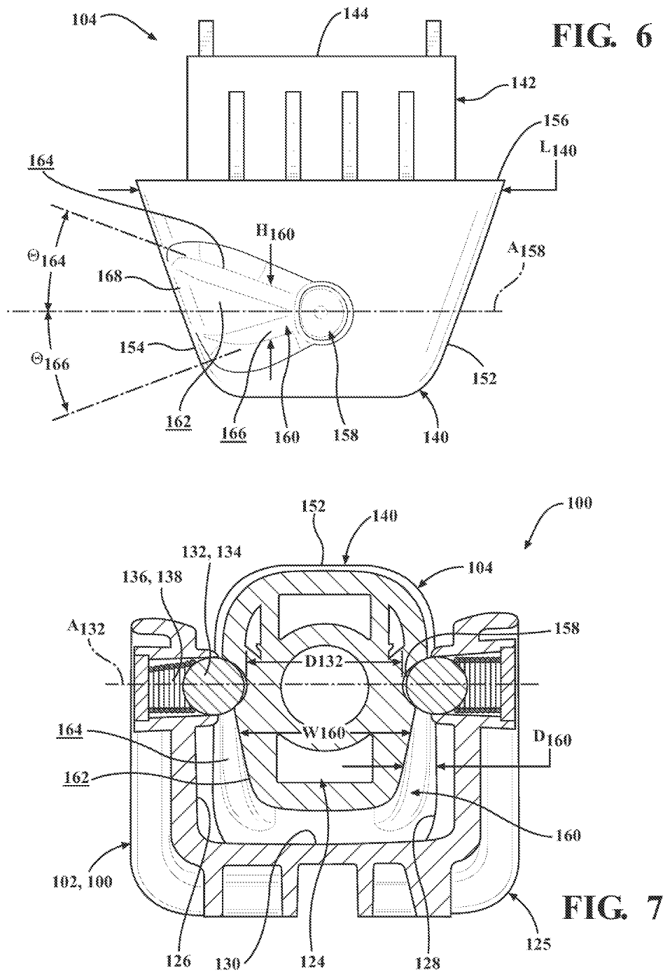

As shown in FIG. 6, the front side 152 of the retainer head 140) and the rear side 154 of the retainer head 140) each extend from the bottom end 146 to the upper side 156 of the retainer head 140, whereby a distance from the front side 152 to the rear side 154 defines a length L₁₄₀ of the retainer head 140. In the illustrated example, the length L₁₄₀ of the retainer head 140 tapers continuously along a direction from the upper side 156 to the bottom end 146. In other words, the front side 152 and the rear side 154 converge with each other along the direction from the upper side 156 to the bottom end 146. While the illustrated example shows the length L₁₄₀ having a constant taper from the upper side 156 to the bottom end 146 (i.e., the sides 152, 154 are straight), other examples may include a variable taper, whereby the sides 152, 154 are arcuate or contoured between the upper side 156 and the bottom end 146. Conversely, the retainer head 140 may have a constant length L₁₄₀, whereby the front side 152 and the rear side 154 are parallel between the upper side 156 and the bottom end 146.

With continued reference to FIGS. 4-6, each of the outboard side 148 and the inboard side 150 of the retainer head 140 includes a detent 158 and a corresponding guide channel 160 configured to receive and engage respective ones of the catches 132 of the retainer receptacle 124 when the retainer head 140 is positioned within the retainer receptacle 124. As best shown in FIGS. 4 and 6, each of the detents 158 includes a recess formed in one of the outboard side 148 or the inboard side 150. Generally, the recess of the detent 158 has a shape configured to receive and mate with one of the catches 132 of the retainer receptacle 124. For example, in the illustrated example, the detents 158 have a hemispherical profile corresponding to the hemispherical profile of the catches 132. In the illustrated example, the detents 158 are disposed at an intermediate portion along the length L₁₄₀ of the retainer head 140, substantially centered relative to the front side 152 and the rear side 154.

Each guide channel 160 is configured to provide a defined passageway extending from the rear side 154 to the detent 158 along the respective one of the outboard side 148 and the inboard side 150. For example, as shown in FIG. 6, the guide channel 160) on the inboard side 150 extends continuously from the rear side 154 to the detent 158. Each guide channel 160 is defined by an inner guide surface 162 that is recessed inwardly from the respective one of the outboard side 148 and the inboard side 150 by a depth D₁₆₀ to define a recess that extends continuously from the rear side 154 to the detent 158.

As illustrated in FIG. 5, the inner guide surfaces 162 of the respective guide channels 160 are parallel to each other along the vertical direction (i.e., from the top end 144 to the bottom end 146). Conversely, as best shown in FIG. 7, the inner guide surfaces diverge from each other along a longitudinal direction of the retainer head 140 from the rear side 154 to the front side 152. Thus, the depth D₁₆₀ of each guide channel 160 tapers or decreases along the direction from the rear side 154 to the detent 158. In other words, a width W₁₆₀ of the retainer head 140) across the guide channels 160 increases from the rear side 154 to the detents 158. In the illustrated example, the width W₁₆₀ at the rear side 154 is less than a distance D₁₃₂ between the catches 132 when the catches 132 are in the natural or unbiased state, while the width W₁₆₀ adjacent to the detents 158 is greater than the distance D₁₃₂ between the catches 132 when the catches 132 are in the natural or unbiased state. Thus, the catches 132 can be received within the guide channels 160 in a loose or slip-fit condition to allow for easy alignment between the catches 132 and the guide channels 160. As the catches 132 are advanced through the guide channels 160) to the detents 158, the slip-fit condition transitions to an interference-fit condition, whereby the catches 132 are biased over the guide channels 160 into the detents 158 and the guide channels 160 function to retain the catches 132 within the detents 158.

A lower boundary of the guide channel 160 is defined by an upper guide surface 164 that connects the inner guide surface 162 to the respective side 148, 150 of the retainer head 140 along an upper portion of the guide channel 160. Similarly, a lower boundary of the guide channel 160 is defined by a lower guide surface 166 that connects the inner guide surface 162 to the respective side 148, 150 of the retainer head 140 along an upper portion of the guide channel 160. Thus, the upper guide surface 164 and the lower guide surface 166 are spaced apart from each other at the rear side 154 to define a mouth or opening 168 to the guide channel 160 on each side 148, 150.

Generally, the upper guide surface 164 and the lower guide surface 166 are configured to converge with each other along the direction from the rear side 154 to the detent to provide a “mouth” for receiving and guiding the catches 132 toward the detents 158. In other words, a distance along the height direction between the upper guide surface 164 and the lower guide surface 166 decreases or tapers along the direction from the rear side 154 to the detent 158. As best shown in FIG. 6, the upper guide surface 164 is formed at an upper guide surface angle θ₁₆₄ relative to a horizontal (i.e., parallel to the upper side 156) detent axis A₁₅₈ associated with a centerline of the detent 158. In the illustrated example, the upper guide surface angle θ₁₆₄ is a first oblique angle relative to the detent axis A₁₅₈. Similarly, and as best shown in FIG. 6, the lower guide surface 166 is formed at a lower guide surface angle θ₁₆₆ relative to a horizontal (i.e., parallel to the upper side 156) axis A₁₅₈ associated with the detent 158. In the illustrated example, the lower guide surface angle θ₁₆₆ is a second oblique angle. The lower guide surface angle θ₁₆₆ is selected such that the lower guide surface 166 is generally oriented towards an eye line of a vehicle occupant O to assist the occupant O in aligning the catches 132 with the guide channels 160. Thus, in some examples, the upper guide surface angle θ₁₆₄ may be parallel to the detent axis A₁₅₈ while the lower guide surface angle θ₁₆₆ is oriented at an oblique angle towards the eye line occupant O.

Referring again to FIGS. 1-3, an example use of the visor system 100 is provided. Initially, in FIG. 1, the visor system 100 is provided in a decoupled state, whereby the retainer receptacle 124 of the visor 102 is disengaged and spaced apart from the visor retainer 104. For example, the visor 102 may be disengaged when an occupant O desires to transition the visor 102 from the windshield-deployed state (e.g., down in the windshield) to the passenger-window-deployed state (e.g., down in the passenger window).

At FIG. 2, the occupant O moves the visor 102 from the decoupled state (FIG. 1) to the coupled state (FIG. 2) by aligning the retainer head 140 within the retainer receptacle 124 such that the retainer head 140) can be received between the outboard side surface 126 and the inboard side surface 128 of the retainer receptacle. Additionally, the occupant O aligns the catches 132 of the retainer receptacle 124 with the openings 168 of the guide channels 160 and initially inserts the catches 132 into the guide channels 160 via the openings 168. With the catches 132 at least partially received within the openings 168, the catches 132 are biased along the guide channels 160 toward the detents 158 by the occupant O. As discussed previously, the width W₁₆₀ across the guide channels 160 transitions from a slip fit to an interference fit along the direction from the openings 168 to the detents 158, whereby the catches 132 may be biased or forced F₁ along the inner guide surfaces 162 and into the detents 158 to provide a “snap” fit within the detents 158. Optionally, as discussed above, the detents 158 may include dynamic detents (e.g., depressible ball bearings) that accommodate the increased width W₁₆₀ and ease insertion.

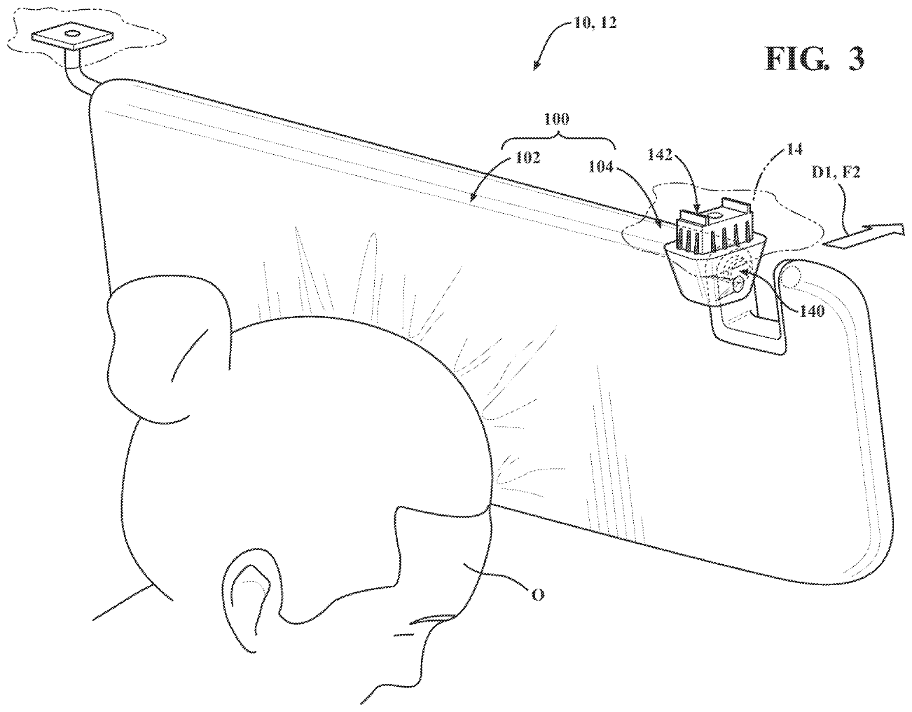

Referring to FIG. 3, the visor 102 may be disengaged from the visor retainer 104 in a vehicle-forward direction (i.e., toward the windshield) during an impact event. For example, the engagement interface between the detents 158 and the catches 132 is configured such that the catches 132 can be disengaged from the detents 158 in the forward direction D1 upon application of a biasing or impact force F₂ on the visor 102. In the illustrated example, the impact force F2 is associated with a cranial impact of the occupant O with the visor panel 108. In this case, the impact force F2 biases the retainer receptacle 124 of the visor panel 108 in the forward direction D1, whereby the catches 132 overcome the force associated with the snap fit and disengage from the detents 158 in a direction towards the front side 152.

As set forth above, the visor system 100 is configured such that the visor panel 108 is configured to disengage from the visor retainer 104 in a direction towards the occupant O during normal use and in an opposite direction D1 away from the occupant O upon application of the impact force F2. By incorporating the visor system 100 of the present disclosure, forces associated with a cranial impact at the visor panel 108 may be minimized by allowing the visor 102 to release in the forward direction D3 during an impact event. This configuration is particularly advantageous in vehicles having relatively low-profile headboards relative to an occupant O height.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A sun visor system for a vehicle, the sun visor system comprising:
a visor panel including a retainer receptacle having at least one catch; and
a retainer including at least one detent configured to selectively engage the at least one catch of the visor panel and to disengage from the at least one catch of the visor panel in a first direction and in an opposite second direction.

2. The sun visor system of claim 1, wherein the retainer includes a retainer head having a first retainer side including a first detent and a second retainer side formed on an opposite side from the first retainer side and including a second detent.

3. The sun visor system of claim 2, wherein the retainer head includes a front side and a rear side at an opposite end from the front side, and each of the first retainer side and the second retainer side extend between the front side and the rear side.

4. The sun visor system of claim 3, wherein the first retainer side includes a first guide channel extending from the rear side to the first detent and the second retainer side includes a second guide channel extending from the rear side to the second detent.

5. The sun visor system of claim 4, wherein each of the first guide channel and the second guide channel includes a height that tapers along a direction from the rear side to the detent.

6. The sun visor system of claim 5, wherein the retainer head includes an upper side and a bottom end formed on an opposite side from the upper side, the front side and the rear side converging along a direction from the upper side to the bottom end.

7. The sun visor system of claim 6, wherein the first guide channel includes a first inner guide surface recessed from the first retainer side and the second guide channel includes a second inner guide surface recessed from the second retainer side.

8. The sun visor system of claim 6, wherein the retainer receptacle includes a first receptacle side including a first catch configured to engage the first detent and a second receptacle side including a second catch configured to engage the second detent.

9. A retainer for a vehicle sun visor system, the retainer comprising:
a retainer head having a first retainer side including a first detent and a second retainer side formed on an opposite side from the first retainer side and including a second detent; and
a retainer anchor extending from the retainer head and configured to secure the retainer to a vehicle body.

10. The retainer of claim 9, wherein the retainer head includes a front side and a rear side at an opposite end from the front side, and each of the first retainer side and the second retainer side extends between the front side and the rear side.

11. The retainer of claim 10, wherein the first retainer side includes a first guide channel extending from the rear side to the first detent and the second retainer side includes a second guide channel extending from the rear side to the second detent.

12. The retainer of claim 11, wherein each of the first guide channel and the second guide channel includes a height that tapers along a direction from the rear side to the respective first detent and second detent.

13. The retainer of claim 12, wherein the retainer head includes an upper side and a bottom end formed on an opposite side from the upper side, the first retainer side and the second retainer side converging along a direction from the upper side to the bottom end.

14. The retainer of claim 13, wherein the first guide channel includes a first inner guide surface recessed from the first retainer side and the second guide channel includes a second inner guide surface recessed from the second retainer side.

15. A motor vehicle comprising:
a vehicle body defining a passenger compartment having a headboard;
a visor panel pivotally attached to the headboard and defining a retainer receptacle having at least one catch; and
a retainer attached to the headboard and including one or more detents configured to selectively engage the catch of the visor panel.

16. The motor vehicle of claim 15, wherein the retainer includes a retainer head comprising:
a front side and a rear side at an opposite end from the front side;
a first retainer side extending between the front side and the rear side and including a first detent and a first guide channel extending from the rear side to the first detent; and
a second retainer side formed on an opposite side from the first retainer side and including a second detent and a second guide channel extending from the rear side to the second detent.

17. The motor vehicle of claim 16, wherein each of the first guide channel and the second guide channel includes a height that tapers along a direction from the rear side to the respective first detent and second detent.

18. The motor vehicle of claim 17, wherein the retainer head includes an upper side and a bottom end formed on an opposite side from the upper side, the first retainer side and the second retainer side converging along a direction from the upper side to the bottom end, and the first guide channel includes a first inner guide surface recessed from the first retainer side and the second guide channel includes a second inner guide surface recessed from the second retainer side and parallel to the first inner guide surface.

19. The motor vehicle of claim 18, wherein the first guide channel diverges from the second guide channel along a direction from the rear side to the first detent.

20. The motor vehicle of claim 19, wherein the first guide channel is parallel to the second guide channel along a direction from the bottom end to the upper side.
